(19) United States
(12) Patent Application Publication
(10) Pub. No.: US 2011/0126014 A1
(43) Pub. Date: May 26, 2011

(54) Event Triggered Pairing of Wireless Communication Devices Based on Time Measurements

(75) Inventors: William O. Camp, Jr., Chapel Hill, NC (US); Leland Scott Bloebaum, Cary, NC (US)

(73) Assignee: Sony Ericsson Mobile Communications AB, Lund (SE)

(21) Appl. No.: 12/789,534

(22) Filed: May 28, 2010

Related U.S. Application Data
(63) Continuation-in-part of application No. 12/624,466, filed on Nov. 24, 2009.

(51) Int. Cl. H04L 9/32; H04B 7/00

(52) U.S. Cl. 713/171; 455/41.2; 380/270; 380/44; 713/168

(57) ABSTRACT

An event-triggered pairing mechanism allows pairing wireless devices having short range interfaces (e.g., Bluetooth devices) by bumping the wireless devices together. A wireless device being paired with a connecting device detects a bump event, determines time information about the bump event, and then generates a private session key based on the time information. Once the devices are paired and the private session key is generated, user content can be securely exchanged between the devices.

### RELATED APPLICATIONS

This application is a continuation-in-part application of U.S. application Ser. No. 12/624,466 entitled, “Event Triggered Pairing of Wireless Communication Devices Based on Time Measurements.” The '466 application, which was filed on Nov. 24, 2009, is expressly incorporated herein by reference in its entirety.

### BACKGROUND

The present invention relates generally to wireless communication devices with short-range radio interfaces and, more particularly, to pairing of two or more wireless communication devices.

Many wireless communication devices include short-range radio interfaces to enable connections to be made with other nearby devices without the need for cords or wires to connect the devices together. Bluetooth is one widely deployed standard for short-range wireless communications. Bluetooth devices can detect and establish connections with other Bluetooth devices as they come into range. The Bluetooth standard includes a procedure called pairing to prevent connections from being established with unknown Bluetooth devices. The pairing procedure typically requires a user to confirm the connection being established by inputting a PIN or passcode for the connecting Bluetooth device.

A recent technology called Bump provides a mechanism for pairing wireless devices without the need for the user to enter a PIN of passcode. There are two main parts to the Bump technology: an application running on the Bluetooth device and a matching algorithm running on a server in a network. The Bluetooth devices are equipped with the Bump application and use sensors to detect and report the bump to the network server. The network server then matches two phones that detect the same bump. The network server uses a complex filtering scheme based on the location of the Bluetooth devices and characteristics of the bump event to match the Bluetooth devices. While the Bump technology simplifies pairing from the user perspective, it requires a server in the network to perform the matching and the Bluetooth devices must have Internet access to use the Bump technology for pairing.

Accordingly, there remains a need for pairing mechanisms that simplify the pairing process from the user perspective without requiring additional hardware or Internet access.

### SUMMARY

The present invention provides an event-triggered pairing mechanism for pairing wireless devices having short range interfaces (e.g., Bluetooth devices) to form an ad hoc network. The pairing process is initiated responsive to a predetermined user action, such as bumping the two wireless devices together once or twice. In response to the predetermined user action, one of the wireless devices generates a private session key based on time information associated with the triggering event. Once generated, the device can send the generated key to the other device. One or both of the devices may then use the session key for almost any use including, but not limited to, encryption, decryption, authentication, digitally signing a given document, and hashing.

In one embodiment, the present invention provides a method of pairing a wireless device with a connecting device. The method is implemented by the wireless device and comprises detecting a bump event, determining time information about the bump event, and generating a private session key from the time information.

In one embodiment, the method further comprises encrypting and/or decrypting user data exchanged with the connecting device using the private session key.

In another embodiment, the method further comprises performing at least one of a unilateral authentication procedure and a bilateral authentication procedure using the private session key.

In one embodiment, the determining time information about the bump event comprises exchanging time information about the bump event with the connecting device.

Exchanging time information about the bump event with a connecting device may comprise sending a request to the connecting device responsive to the bump event, and receiving first time information from the connecting device responsive to the request.

In one embodiment, exchanging time information about the bump event with a connecting device further comprises sending second time information to the connecting device.

In some embodiments, generating a private session key from the time information comprises generating the private session key from at least one of the first and second time information.

In at least one embodiment, generating a private session key from the time information further comprises inputting the time information into a key generation function, and using the resulting value as the private session key.

In one embodiment, inputting the time information into a key generation function comprises adjusting the time information to eliminate differences in the time information between the wireless device and the connecting device, and inputting the adjusted time information into the key generation function.

In one embodiment, generating a private session key from the time information comprises generating the private session key responsive to receiving a key exchange request from the connecting device.

In one embodiment, the method further comprises obtaining a public key for the connecting device, encrypting the generated private session key using the public key, and sending the encrypted private session key to the connecting device.

In one embodiment, the present invention provides a wireless device capable of exchanging data with a connecting device. The wireless device may comprise a short-range radio transceiver for communicating with other wireless devices and a processing circuit unit operatively connected to the transceiver. The processor is configured to detect a bump event, determine time information about the bump event, and generate a private session key from the time information.

In one embodiment, the processing circuit is configured to determine time information about the bump event by exchanging the time information about the bump event with the connecting device.

The processing circuit may, in one embodiment, exchange the time information by sending a request to the connecting device responsive to the bump event, and receiving first time information from the connecting device responsive to the request.

The processing circuit may also send second time information to the connecting device.

In one embodiment, the processing circuit is further configured to generate the private session key from at least one of the first and second time information.

In one embodiment, the processing circuit is configured to generate the private session key by inputting the time information into a key generation function, and using the resulting value as the private session key.

In at least one embodiment, the processing circuit is further configured to adjust the time information to eliminate differences in the time information between the wireless device and the connecting device, and input the adjusted time information into the key generation function.

In one embodiment, the processor is further configured to generate the private session key responsive to receiving a key exchange request from the connecting device.

In one embodiment, the processor is further configured to obtain a public key for the connecting device, encrypt the generated private session key using the public key, and send the encrypted private session key to the connecting device.

In one embodiment, the processing circuit is further configured to detect at least one of sound or motion associated with the bump event.

The time information may comprise, for example, one of the time of the bump event, an elapsed time from the bump event, or a time interval between the first and second bumps in the bump event.

In one embodiment, the processor is configured to perform at least one of a unilateral authentication procedure and a bilateral authentication procedure using the private session key.

In another embodiment, the present invention provides a method of pairing a wireless device with a connecting device. The method is implemented by the wireless device and comprises detecting a bump event, receiving a request from a connecting device responsive to the bump event, and generating, responsive to the request, a private session key from first time information about the bump event.

In one embodiment, the method further comprises encrypting the generated private session key using a public key associated with the connecting device, sending the encrypted private session key to the connecting device, and encrypting and/or decrypting user data exchanged with the connecting device using the generated private session key.

In another embodiment, the method further comprises authenticating the wireless device to the connecting device based on the generated private session key.

In another embodiment, the method comprises receiving a session key from the connecting device, and authenticating the connecting device based on the received session key.

The request may comprise, for example, one of an authentication request and a key generation request.

The present invention also provides wireless comprising a short-range radio transceiver for communicating with a other wireless devices and a processing circuit unit operatively connected to the transceiver. In one embodiment, the processing circuit is configured to detect a bump event, receive a request from a connecting device responsive to the bump event, and generate, responsive to the request, a private session key from first time information about the bump event.

In one embodiment, the processing circuit is further configured to encrypt the generated private session key using a public key associated with the connecting device, send the encrypted private session key to the connecting device, and encrypt and/or decrypt user data exchanged with the connecting device using the generated private session key.

### BRIEF DESCRIPTION OF THE DRAWINGS

FIG. 1 illustrates two exemplary wireless devices being paired by bumping the wireless devices together;

FIG. 2 illustrates an exemplary method for pairing wireless devices.

FIG. 3 illustrates an exemplary procedure for exchanging a private session key between two wireless devices during a pairing procedure.

FIG. 4 illustrates an exemplary procedure for exchanging a private session key between two wireless devices.

FIG. 5 illustrates an exemplary wireless device.

### DETAILED DESCRIPTION

The present invention relates to a method of pairing wireless devices 10 to enable the exchange of data by the devices 10 over a short range radio interface. The wireless devices 10 may comprise, for example, cell phones, personal digital assistants, smart phones, handheld computers, audio or any other devices 10 having wireless communication capabilities.

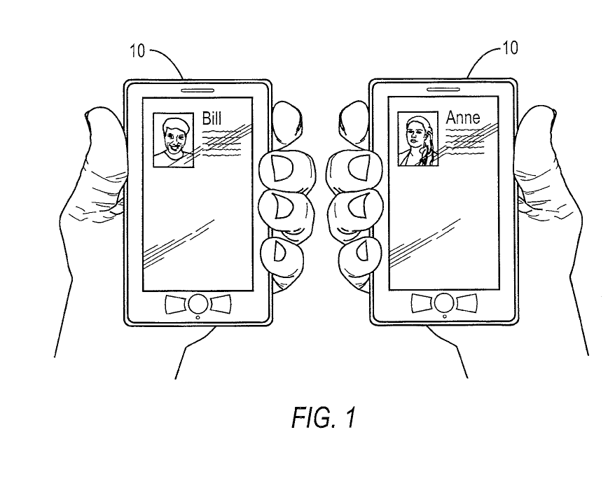

FIG. 1 illustrates two smart phones owned by users (denoted as Ann and Bill) who wish to exchange contact information. For purposes of explanation, it is assumed that the smart phones each include a Bluetooth module that allows communication with other Bluetooth devices over short distances. Those skilled in the art will appreciate that other short range wireless communication technologies can also be used in the present invention. The Bluetooth standard includes a procedure called pairing to prevent connections from being established with unknown devices. The pairing procedure requires a user to confirm the user's desire to make the connection, typically by inputting a PIN or passcode for the connecting device. The present invention simplifies the pairing process from the user standpoint and eliminates the need for the user to input a PIN or passcode.

According to one embodiment of the present invention, the pairing procedure is initiated by a user action that implicitly indicates the user's desire to establish a connection between the user's own wireless device 10 and a connecting wireless device 10. For example, two users wishing to connect their wireless devices 10 to exchange data may bump their wireless devices 10 (or hands holding the wireless devices) together once or twice. The “bump” initiates the pairing process and time measurements relating to the “bump” are used for either unilateral or bilateral authentication. When the pairing procedure is finished, the wireless devices 10 are then authenticated to exchange user content, such as the contact information shown in FIG. 1. Any type of user content can be exchanged in this manner, including music files, ringtones, images, data files, and applications.

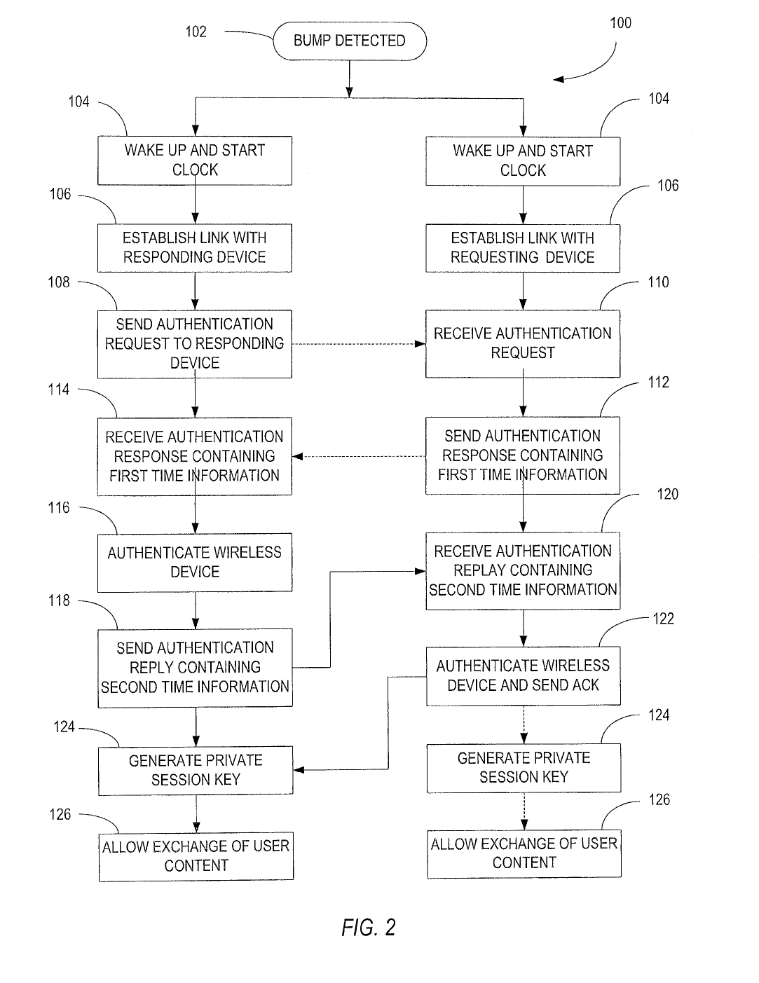

FIG. 2 illustrates an exemplary method 100 of pairing two wireless devices 10. During the pairing procedure, one of the wireless devices 10 functions as a requesting device 10 and the other functions as a responding device 10. The operations represented on the left side of FIG. 2 are performed by the requesting device 10, while the operations shown on the right side of FIG. 2 are performed by the responding device 10. It is assumed that the wireless devices 10 include a microphone, accelerometer, and/or other sensor to detect a triggering event, such as a bump. More generally, the triggering event can be any user initiated action that can be detected by the sensors of the wireless devices 10. Preferably, the triggering event is of a type that would not likely be detected by other nearby devices 10.

In the exemplary embodiments, the two wireless devices 10 are bumped together once or twice. The “bump event” is detected by microphones and/or accelerometers in the wireless devices 10 (block 102). In one embodiment, the sound generated by the bump event is detected by microphones. In addition to the sounds detected by microphones, the movement of one or both of the wireless devices 10 that produced the sound generating bump may be detected by an accelerometer in the wireless device 10.

In response to the bump event, the wireless devices 10 wake up if they are in a sleep mode and start a clock or timer (block 104). In one exemplary embodiment, a low level program running up both wireless devices 10 monitors the audio output from the microphone and/or electrical output of the accelerometer. The main processor of the wireless devices 10 can be dormant and activated by an interrupt signal from the microphone and/or accelerometer hardware. When sound or motion associated with a bump is detected, the first program wakes up the processor and starts a second program that analyzes the electrical signals output from the microphone and/or accelerometer. For example, the second program may compare the signals output by the microphone and/or accelerometer to a threshold and/or stored bump signatures to determine whether a bump event occurred. The bump signatures can be determined by experimentation and stored in the memory of the wireless devices. The bump signatures can be device dependent or device independent. Device dependent signatures can account for resonances in the wireless device and may be more reliable than device independent signatures at the expense of greater complexity. In one embodiment, the bump signatures may be related to a predetermined location on the wireless device so that pairing is initiated by bumping the wireless device at the predetermined location. The bump signatures provide the capability to filter out unintentional bumps and other typical bumps that occurs during ordinary use of the wireless devices.

If the bump event is confirmed, the second program starts a clock and initiates the pairing procedure. If the Bluetooth modules in the two devices 10 are off, the second program turns the Bluetooth modules on and begins searching for nearby devices 10. If the wireless devices 10 detect one another, the wireless devices 10 establish a radio link (block 106). If the wireless devices 10 do not detect other devices 10, the programs in the two wireless devices terminate.

After a radio link is established, the requesting device 10 sends an authentication request to the responding device 10 (block 108). When the responding device 10 receives the authentication request (block 110), it determines a first time measurement related to the bump event. For example, the first time measurement may comprise the elapsed time from the detection of the bump event, or, if the devices 10 are bumped twice, the time interval between the two bumps. The time measurement could also be a calculated value, such as the computed time of the bump event. The responding device 10 sends the first time measurement to the requesting device 10 in an authentication response (block 112).

When the requesting device 10 receives the authentication response (block 114), it verifies the accuracy of the first time measurement (block 116). More particularly, the requesting device 10 compares the time measurement received in the authentication response with its own time measurement to authenticate the responding device 10. If the time measurement received from the responding device 10 is within predetermined tolerance parameters (e.g. a few milliseconds), the requesting device 10 authenticates the responding device 10 and allows the exchange of user data. In cases where the unilateral authentication is sufficient, the authentication procedure can end at this point. For example, if a wireless device 10 such as a smart phone is being paired with a headset, unilateral authentication of the headset by the smart phone is sufficient for pairing. In such cases, the requesting device 10 sends an acknowledgement back to the responding device 10 to complete the authentication procedure.

In cases where bilateral authentication is needed, such as when two users are exchanging data, the requesting device 10 may transmit a second time measurement (e.g., the elapsed time or time interval between two bumps) to the responding device 10 in an authentication reply (block 118). When the responding device 10 receives the authentication reply (block 120), the responding device 10 compares the received time measurement with its own time measurements to verify the accuracy of the second time measurement to authenticate the requesting device 10 (block 122). If the second time measurement received from the requesting device 10 falls within predetermined tolerance parameters, the requesting device 10 is authenticated to the responding device 10 and the responding device 10 sends an acknowledgement message (ACK) to the requesting device 10 (block 122).

When both wireless devices are authenticated, the wireless devices may then optionally use the time measurements to generate a private session key for encrypting and/or decrypting communications (block 124). For example, the wireless devices 10 can input one or both time measurements into a predetermined key generation algorithm. Key generation algorithms are well known in the art and are described in Bruce Schneier, Applied Cryptography (2nd Ed.). To ensure that both devices use the same value as an input to the key generation algorithm, it may be necessary to round the time measurements to eliminate differences in the least significant bits of the time measurements. In one exemplary embodiment, the time interval measurement is rounded and used as an input because it is likely to be more accurate than the elapsed time measurement and thus requires less rounding to ensure that identical values are used.

After both devices 10 have been authenticated, the wireless devices 10 then allow the exchange of data between the authenticated devices (block 126). In one embodiment, preselected user content can be exchanged automatically upon successfully authenticating the connecting devices. In one exemplary embodiment, one or both users select via a user interface content to exchange with a connecting device. The user selection may occur prior to bumping the devices together. Alternatively, the users may be prompted to select content after the bump is detected. The process for selection of user content can be parallel to the authentication procedure. In other embodiments, no user selection of content is needed. For example, when a smart phone is being paired with a Bluetooth headset, the wireless device can allow exchange of voice data with the headset automatically without user input. Whether user selection is required for exchange of data may thus depend on the type of one or both of the connecting devices.

The exchange of time information related to the bump event protects both device 10 from a malicious third party or eavesdropper. A malicious third party could receive the authentication request from the requesting device 10, but would not likely be able to supply a correct time measurement. The responding device 10 is also protected because it receives a different time measurement. The exchange of user data does not begin until both devices 10 are properly authenticated.

As noted above, the wireless devices may use the time measurements exchanged during the pairing process to generate a private session key for encrypting and/or decrypting user data exchanged between two wireless devices 10. For example, the time measurements exchanged during the pairing procedure may be input to a key generation algorithm that generates a common key that is known only to the two wireless devices 10 being paired. The resulting key may then be used as a private session key to encrypt and decrypt information exchanged between the paired wireless devices 10. Alternatively, only one of the two devices 10 may generate a private session key using the time measurements exchanged during the pairing procedure. The wireless device 10 that generates the session key may then obtain a public key for the other device 10, encrypt the private session key using the public key, and send the encrypted private session key to the other device 10.

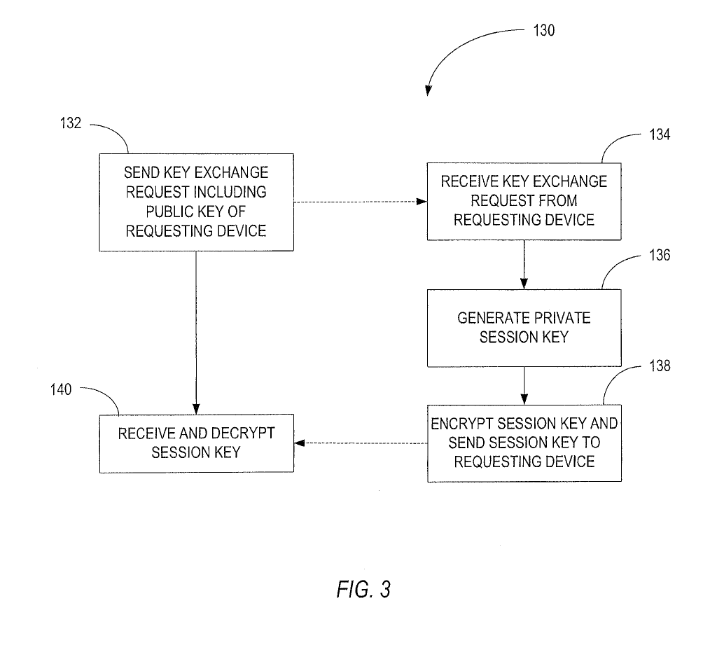

FIG. 3 illustrates an exemplary key exchange procedure 130 according to one embodiment, which may be used at block 124 of FIG. 2 The requesting device 10 initiates the key exchange procedure by sending its public key to the responding device 10 (block 132). When the responding device receives the key exchange request (block 134), it uses the time measurements previously exchanged during the pairing procedure to compute a private session key (block 136). For example, one or more time measurements can be input to a hash algorithm to generate a secret key. The algorithm used for generating the private session key does not have to be known to the requesting device 10. The responding device 10 encrypts the private session key with the requesting device's public key and sends the encrypted key back to the requesting device 10 (block 138). The requesting device 10 receives and decrypts the private session key (block 140). Thus, both devices 10 have the same secret session key to use for subsequent secured data communications.

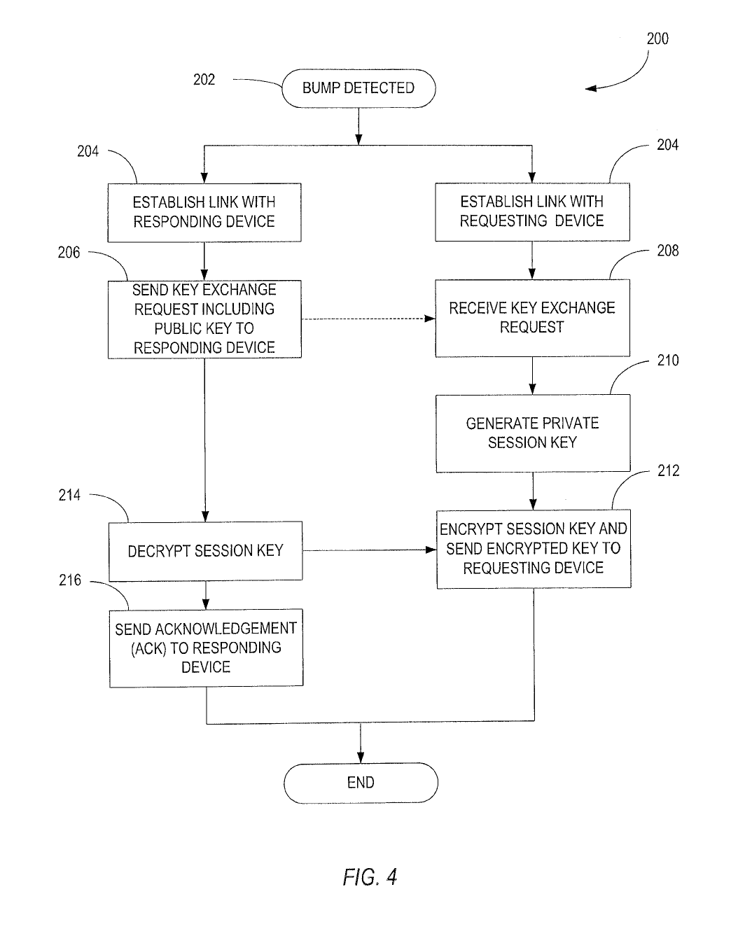

Those skilled in the art will appreciate that the key exchange procedure shown in FIG. 3 can be performed independently of the authentication procedure. FIG. 4 shows an exemplary key exchange procedure 200 according to one embodiment. The key exchange process begins when the two devices 10 are bumped together. The bump may be detected by a microphone and/or accelerometer as previously described. In response to the detection of the bump event, the two wireless devices 10 establish a radio link (block 204). The requesting device 10 then sends a key exchange request to the responding device 10 (block 206). The key exchange request contains the public key of the requesting device 10. Upon receipt of the key request (block 208), the responding device 10 performs time measurements related to the bump event and uses the time measurements as an input to a key generation algorithm (block 210). The resulting session key is encrypted and sent back to the requesting device 10 in a key exchange response (block 212). The requesting device 10 decrypts the private session key (block 214) and sends an acknowledgement back to the responding device 10 to indicate the successful receipt of the session key (block 216).

As previously stated, the session key may be used to encrypt and/or decrypt user data exchanged between the devices 10. However, this is not the only use for the generated session key. The session key may also be used for almost any function. In some embodiments, the session key could be used to hash documents or digitally sign documents. In other embodiments, the generated key may be used by one device 10 to authenticate itself to the other device 10 (e.g., in a unilateral authentication procedure), or by both devices 10 to authenticate the devices 10 to each other (e.g., in a bilateral authentication procedure). By way of example, each device 10 could independently generate its own session key. Both devices 10 would have access to the same time information and would also include the same key generation function, and therefore, the generated session keys would be the same. In a unilateral procedure, a first device 10 could send its generated private session key to a second device 10. A simple comparison performed at the second device 10 would be enough to authenticate the first device 10. In a bilateral authentication procedure, each device 10 could send the other device 10 its generated session key. A simple comparison performed at each device 10 would authenticate the devices 10 to each other. To help ensure further security, one or both of the devices 10 could first encrypt its generated session key using a public key of the other device. Each device 10 would then send its encrypted session key to the other device. Upon receipt, each device 10 would decrypt the session key and authenticate the other device 10.

In some embodiments of the invention, a session re-establishment procedure is provided for re-establishing a session that has been interrupted. If the session key is deemed to be secure, the session between the two devices 10 may be re-established by bumping the devices 10 together. If the previous session key is judged to be insecure, the devices 10 may need to repeat the pairing process previously described. Thus, secure reconnections can be made automatically by bumping the two phones together as long as the private session key remains valid.

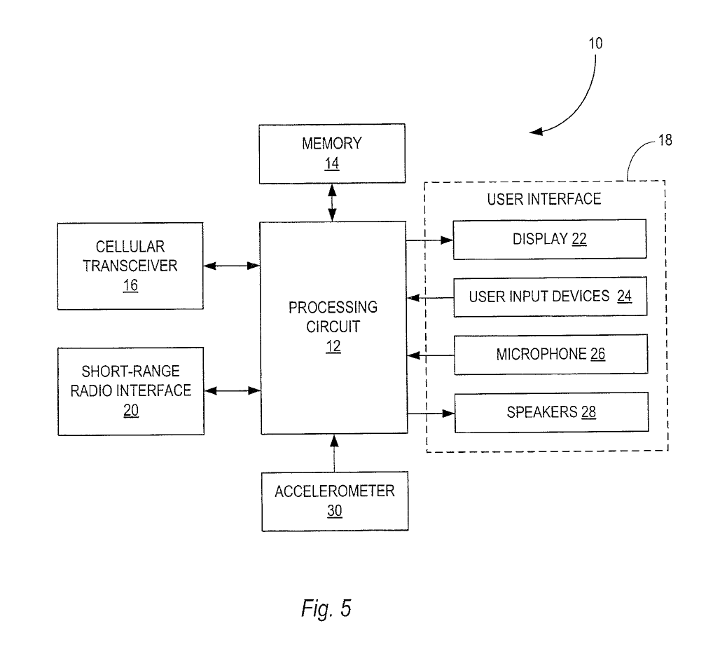

FIG. 5 illustrates the main functional components of an exemplary wireless device 10 according to one embodiment of the present invention. The wireless device 10 comprises processing circuits 12, memory 14, cellular transceiver 16, user interface 18, and short-range radio interface 20. The processing circuit 12 comprises one or more microprocessors, microcontrollers, hardware, or a combination thereof. Processing circuits 12 execute programs and applications stored in memory 14, process signals transmitted and received by the wireless device, and control the overall operation of the wireless device 10 as described above. Memory comprises one or more memory devices to store programs and data needed for operation on either a temporary or permanent, or semi-permanent basis. Memory devices may include, for example volatile memory (e.g., RAM) and/or nonvolatile memory (ROM, EEPROM, Flash). Cellular transceiver 16 is a fully functional cellular transceiver to enable the wireless device to communicate over cellular networks such as Wideband Code Division Multiple Access (WCDMA) networks, Long Term Evolution (LTE) networks, or WiMAX networks. User interface 18 include input and output device to enable a user to interact with and control the wireless device. The user interface may include for example, a display 22 to output information for viewing by the user and one or more input devices 24 such as keypads, dials, wheels, function keys, touch pads, etc. Some devices 10 may include a touch screen display that also functions as an input device. The user interface 18 may also include a microphone 24 to convert audible sounds into audio signals for input to the processing circuits 12, and one or more speakers 28 to convert audio signals output by the processing circuit 12 into audible sounds that can be heard by the user. Short-range radio interface 20 includes any type of radio interface, such as a Bluetooth interface, that enables connections with other nearby devices. The wireless device 10 may further include a motion sensor 30, such as an accelerometer, to detect movement of the wireless communication device.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method implemented by a wireless device of pairing with a connecting device, the method comprising:
detecting a bump event;
determining time information about the bump event; and
generating a private session key from the time information.

2. The method of claim 1 further comprising encrypting and/or decrypting user data exchanged with the connecting device using the private session key.

3. The method of claim 1 further comprising performing at least one of a unilateral authentication procedure and a bilateral authentication procedure using the private session key.

4. The method of claim 1 wherein determining time information about the bump event comprises exchanging time information about the bump event with the connecting device.

5. The method of claim 4 wherein exchanging time information about the bump event with a connecting device comprises:
sending a request to the connecting device responsive to the bump event; and
receiving first time information from the connecting device responsive to the request.

6. The method of claim 5 wherein exchanging time information about the bump event with a connecting device further comprises sending second time information to the connecting device.

7. The method of claim 6 wherein generating a private session key from the time information comprises generating the private session key from at least one of the first and second time information.

8. The method of claim 1 wherein generating a private session key from the time information comprises:
inputting the time information into a key generation function; and
using the resulting value as the private session key.

9. The method of claim 8 wherein inputting the time information into a key generation function comprises:
adjusting the time information to eliminate differences in the time information between the wireless device and the connecting device; and
inputting the adjusted time information into the key generation function.

10. The method of claim 1 wherein generating a private session key from the time information comprises generating the private session key responsive to receiving a key exchange request from the connecting device.

11. The method of claim 10 further comprising:
obtaining a public key for the connecting device;
encrypting the generated private session key using the public key; and
sending the encrypted private session key to the connecting device.

12. A wireless device capable of exchanging data with a connecting device, the wireless device comprising:
a short-range radio transceiver for communicating with other wireless devices;
a processing circuit unit operatively connected to the transceiver and configured to:
detect a bump event;
determine time information about the bump event; and
generate a private session key from the time information.

13. The wireless device of claim 12 wherein the processing circuit is configured to determine time information about the bump event by exchanging the time information about the bump event with the connecting device.

14. The wireless device of claim 13 wherein the processing circuit is configured to:
send a request to the connecting device responsive to the bump event; and
receive first time information from the connecting device responsive to the request.

15. The wireless device of claim 14 wherein the processing circuit is configured to send second time information to the connecting device.

16. The wireless device of claim 15 wherein the processing circuit is further configured to generate the private session key from at least one of the first and second time information.

17. The wireless device of claim 12 wherein the processing circuit is configured to generate the private session key by:
inputting the time information into a key generation function; and
using the resulting value as the private session key.

18. The wireless device of claim 17 wherein the processing circuit is further configured to:
adjust the time information to eliminate differences in the time information between the wireless device and the connecting device; and
input the adjusted time information into the key generation function.

19. The wireless device of claim 12 wherein the processor is further configured to generate the private session key responsive to receiving a key exchange request from the connecting device.

20. The wireless device of claim 19 wherein the processor is further configured to:
obtain a public key for the connecting device;
encrypt the generated private session key using the public key; and
send the encrypted private session key to the connecting device.

21. The wireless device of claim 12 wherein the processing circuit is further configured to detect at least one of sound or motion associated with the bump event.

22. The wireless device of claim 12 wherein the time information comprises one of the time of the bump event, an elapsed time from the bump event, or a time interval between the first and second bumps in the bump event.

23. The wireless device of claim 12 wherein the processor is configured to perform at least one of a unilateral authentication procedure and a bilateral authentication procedure using the private session key.

24. A method implemented by a wireless device of pairing with a connecting device, the method comprising:
detecting a bump event;
receiving a request from a connecting device responsive to the bump event;
generating, responsive to the request, a private session key from first time information about the bump event.

25. The method of claim 24 further comprising:
encrypting the generated private session key using a public key associated with the connecting device; and
sending the encrypted private session key to the connecting device; and
encrypting and/or decrypting user data exchanged with the connecting device using the generated private session key.

26. The method of claim 24 further comprising authenticating the wireless device to the connecting device based on the generated private session key.

27. The method of claim 24 further comprising:
receiving a session key from the connecting device; and
authenticating the connecting device based on the received session key.

28. The method of claim 24 wherein the request comprises one of an authentication request and a key generation request.

29. A wireless device comprising:
a short-range radio transceiver for communicating with a other wireless devices;
a processing circuit unit operatively connected to the transceiver and configured to:
detect a bump event;
receive a request from a connecting device responsive to the bump event;
generate, responsive to the request, a private session key from first time information about the bump event.

30. The wireless device of claim 29 wherein the processing circuit is further configured to:
encrypt the generated private session key using a public key associated with the connecting device; and
send the encrypted private session key to the connecting device; and
encrypt and/or decrypt user data exchanged with the connecting device using the generated private session key.
